(19) United States
(12) Patent Application Publication
(10) Pub. No.: US 2016/0089682 A1
(43) Pub. Date: Mar. 31, 2016

(54) SPRAY MANIFOLD WITH INDIVIDUAL LIQUID FEED SPRAY GUNS

(71) Applicant: SPRAYING SYSTEMS CO., Wheaton, IL (US)

(72) Inventors: David C. Huffman, Merrimack, NH (US); Russell R. Frechette, Pelham, NH (US); Joseph P. Szczap, Naperville, IL (US); Bo R. Buhl, Walnut Creek, CA (US)

(21) Appl. No.: 14/786,195

(22) PCT Filed: Apr. 23, 2014
(86) PCT No.: PCT/US2014/035081

§ 371 Date: Oct. 22, 2015

Related U.S. Application Data
(60) Provisional application No. 61/815,125, filed on Apr. 23, 2013.

(51) Int. Cl. B05B 7/08; B05B 13/02; B05B 15/04; B05B 1/30

(52) U.S. Cl. CPC B05B 7/0815; B05B 1/3013; B05B 13/0278; B05B 15/0406

(57) ABSTRACT

A modular spray gun manifold having a plurality of spray gun modules arranged in a lateral array each separated by an adjacent support assembly. Each spray gun module has a central liquid passage communicating with a spray nozzle and a transversely oriented liquid inlet port communicating through an outer side of the spray gun module for connection with an independently controllable liquid supply. The spray gun modules further include a recirculation port communicating between the central passageway and a recirculation conduit in an adjacent support assembly. A control valve of each module is operable when in open spraying position for blocking communication of liquid from the central passageway to the circulation port and when in a valve closing position blocking the liquid flow to the spray nozzle while redirecting liquid from the liquid inlet to the recirculation port for recirculation through the manifold array.

### CROSS-REFERENCE TO RELATED APPLICATION

This patent application claims the benefit of U.S. Patent Application No. 61/815,125, filed Apr. 23, 2013, which is incorporated by reference.

### FIELD OF THE INVENTION

The present invention relates generally to spray gun type liquid spray devices, and more particularly, to a spray gun manifold having a modular construction.

### BACKGROUND OF THE INVENTION

Modular spray gun manifold assemblies that include a plurality of laterally spaced spray guns supported in a row for discharging an elongated spray pattern are known. Such manifolds are used, for example, in pill coating machines in the pharmaceutical industry. Spray gun manifolds, such as shown in U.S. Pat. No. 7,083,121 B2 assigned to the same assignee as the present application, the disclosure of which is incorporated herein by reference, comprise spray gun modules disposed between respective support assemblies through which pressurized air and liquid are directed for supplying the plurality of spray gun modules. Liquid directed through the manifold also is recirculated back to the liquid supply.

In some spray applications, it is desirable to monitor the liquid supply to each individual spray gun module in order to detect possible blockage in the spray discharge. For this purpose, it has been necessary to individually supply pressurized liquid to the spray gun modules, rather than through the manifold system, in order to more reliably detect the interruption of discharge of the individual spray gun. While it is also desirable that the liquid be continuously recirculated through the system, when pressurized liquid is individually supplied to the spray gun modules, rather than through the manifold system, this has presented problems.

### OBJECTS AND SUMMARY OF THE INVENTION

It is an object of the present invention to provide a modular spray gun manifold in which the plurality of spray gun modules have individual pressurized liquid feeds and which facilitates efficient recirculation of the liquid.

Another object is to provide a novel spray gun module for use in such a manifold system.

A further object is to provide a spray gun module of the foregoing type which is relatively simple in construction and lends itself to economical manufacture and reliable usage.

Other objects and advantages of the invention will become apparent upon reading the following detailed description and upon reference to the drawings, in which:

### BRIEF DESCRIPTION OF THE DRAWINGS

FIG. 1 is a perspective of an illustrative modular spray gun manifold in accordance with the invention mounted on a support structure;

FIG. 2 is a partially diagrammatic depiction of the spray gun manifold shown in FIG. 1;

FIG. 3 is an enlarged, partially exploded, perspective of the modular spray gun manifold shown in FIG. 2, showing one of the spray gun modules and the adjacent support assemblies in separated relation to each other;

FIG. 4 is a vertical section of one of the spray gun modules of the illustrated manifold showing a flow control valve thereof in an open position;

FIG. 4A is an enlarged fragmentary section of the discharge end of the spray gun module shown in FIG. 4;

FIG. 5 is an end view of the discharge end of the spray gun module shown in FIG. 4;

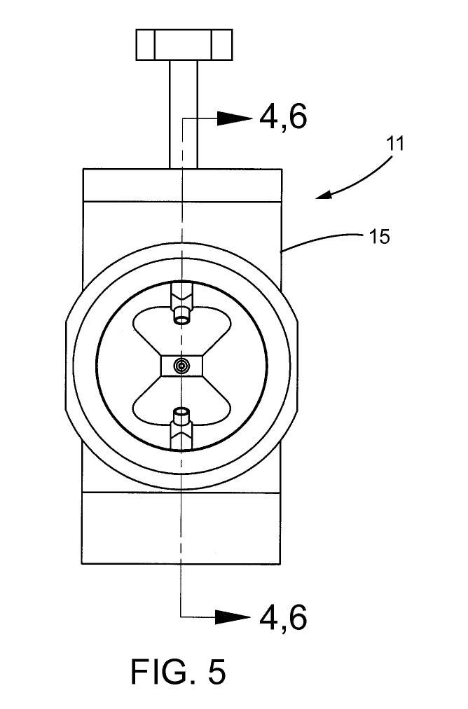

FIG. 6 is a vertical section of the spray gun module, similar to FIG. 4, showing the flow control valve end of the module in an closed position; and

FIG. 6A is an enlarged fragmentary section of the discharge end of the spray gun module shown in FIG. 6

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the invention is to cover all modifications, alternative constructions, and equivalents falling within the spirit and scope of the invention.

### DESCRIPTION OF THE PREFERRED EMBODIMENT

Referring now more particularly to the drawings, there is shown an illustrative modular spray gun manifold 10 which includes a plurality of spray gun modules 11 in accordance with the invention. The spray gun modules 11 each are interposed between support assemblies 12, and the manifold 10 in this case is mounted on a support pipe 14 by laterally spaced brackets 15.

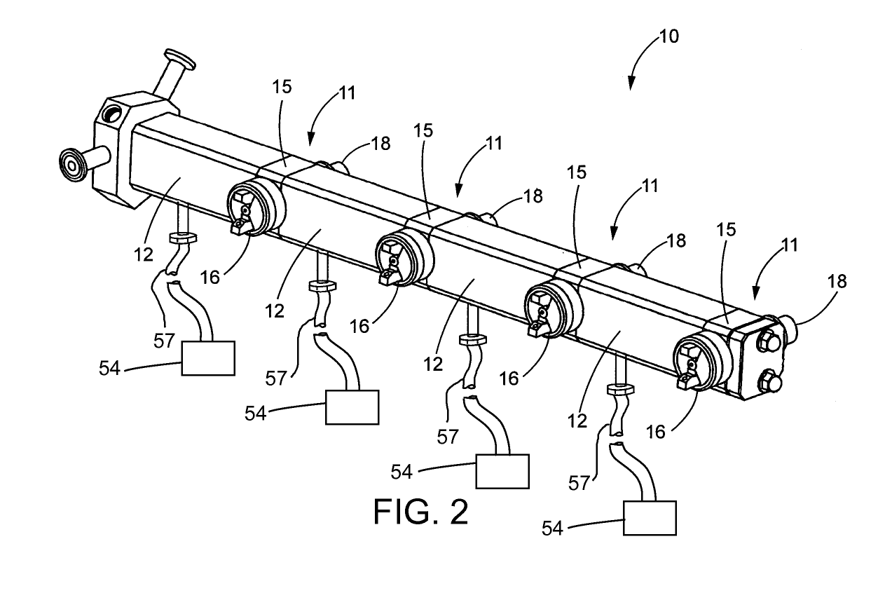

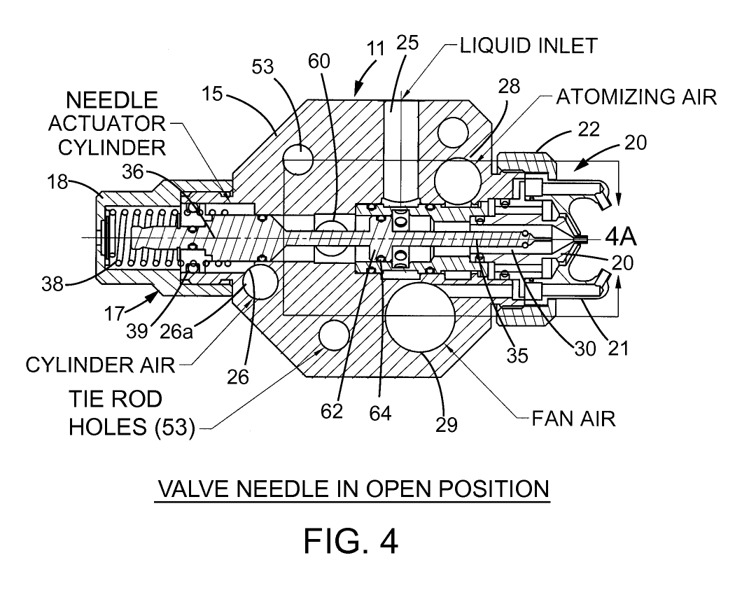

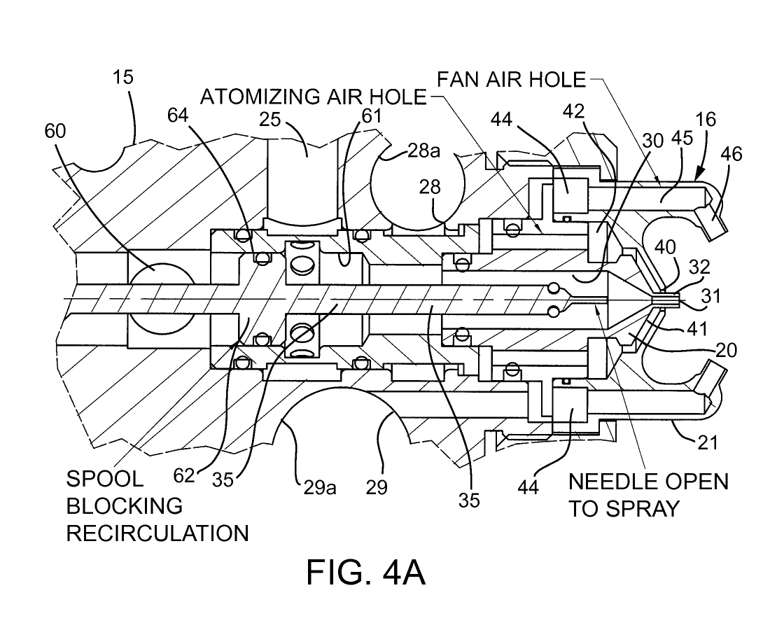

Each spray gun module 11 includes a generally blocked shaped body 15, a spray nozzle assembly 16 supported at one end of the module body 15, and a valve actuator 17, and end cap 18 supported at the opposite end of the modular body 15, as depicted in FIGS. 2 and 4. The illustrated spray nozzle assembly 16 includes a spray tip or nozzle insert 20 and an air cap 21 mounted in overlying surrounding relation to the spray tip 20 (FIG. 4A) and retained on the nozzle body 15 by a retaining nut 22. The nozzle body 15 has a liquid inlet 25, a cylinder air inlet 26, an atomizing air inlet 28, and a fan air inlet 29 (FIG. 4). Liquid is supplied to the inlet 25 communicates with a central longitudinal passageway 30 in the nozzle body 15 and spray tip 20 and through a liquid discharge orifice 31 defined by a forwardly extending nose portion 32 of the spray tip 20 (FIG. 4A).

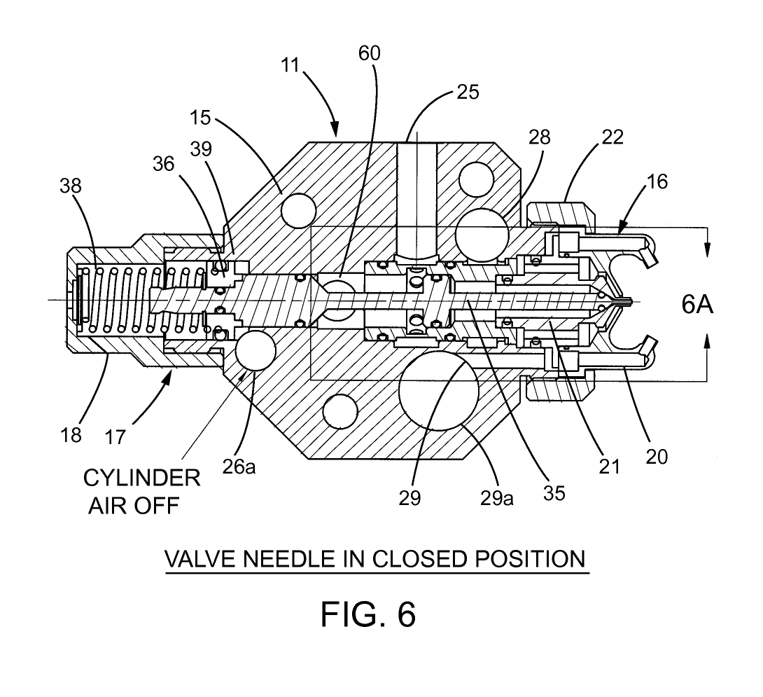

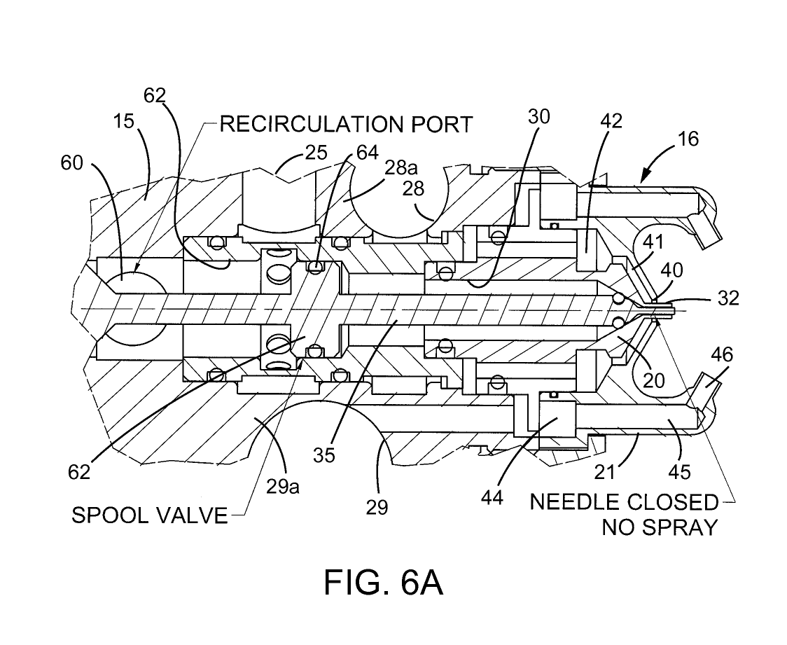

For controlling the discharge of liquid from the spray gun module 11, a valve needle 35 coaxially extends through the housing body 15 for reciprocating movement between a valve closing position in seated engagement with a downstream tapered entry section of the spray tip passageway 30 and an unseated valve open position. The valve needle 35 in this case has a tapered seating section and an axially extending clean out nose portion that is positionable into and through the discharge orifice 31 when in a closed position (FIG. 6A) for maintaining the passage free of buildup during usage.

For operating the valve needle 35, a piston 36 is mounted at an upstream end of the needle 35 which is biased in a valve closing direction by a compression spring 38 interposed between the piston 36 and the upstream actuator cap 18 (FIG. 4). The piston 36 carries an annular sealing ring 39 in sealing engagement with a cylindrical bore in the housing body 15. The compression spring 38 biases the piston 36, and hence the valve needle 35, forwardly to a fully seated, i.e., valve closed position, depicted in FIG. 6. The valve needle 35 is moveable axially in the opposite direction (to the left in FIG. 6) against the force of the spring 38 by pressurized air (i.e. “cylinder air”) selectively directed into the cylinder air inlet 26, which communicates through the housing body 15 with an air chamber on the downstream side of the piston 36 in a known manner.

For atomizing the liquid discharging from the spray tip 20, the spray tip nose portion 32 and a central orifice of the air cap 21 define an annular atomizing air discharge orifice 40 which communicates with angled atomizing air passages 41 and an annular air passage 42 defined between the spray tip 20 and air cap 21, which in turn communicates through nozzle body 15 with the atomizing air inlet 28. Pressurized air directed through the annular discharge orifice 40 communicates outwardly in surrounding relation to the liquid discharge orifice 31 for interaction with the discharging liquid flow stream.

For forming and directing the discharging liquid spray into a flat fan spray pattern for wider lateral application, each spray gun module 11 is operable for impinging pressurized air (i.e., “fan air”) on opposite sides of the liquid spray. Pressurized air from the fan air inlet 29 of the spray gun module 11 communicates through the nozzle body 15 with an annular chamber 44 adjacent an upstream end of the air cap 21. The annular chamber 44 communicates pressurized air to a pair of longitudinal passages 45, which terminate in opposed angled discharge passages 46 that direct pressurized air streams at an acute angle on opposite sides of the discharging liquid spray for spreading the liquid spray into a relatively flat narrow spray pattern.

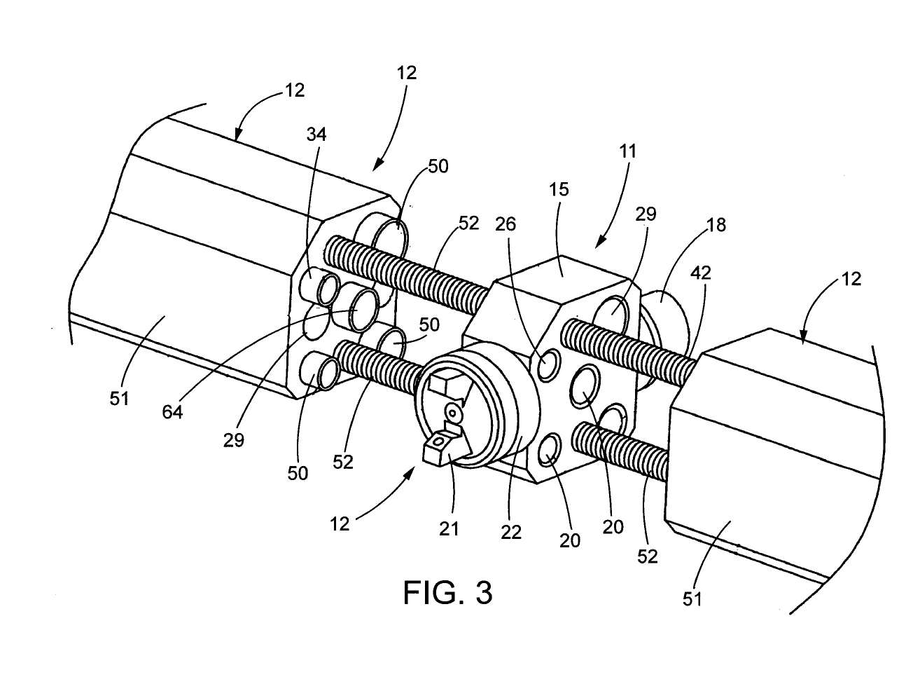

For communicating atomizing air, fan air, and control air to the spray gun modules 11, the cylinder air inlet 26, atomizing air inlet 28, and fan air inlet 29 each is defined by a respective fluid passage 26a, 28a and 29a that extend transversely through opposite sides of the module body and which communicate with fluid conduits 50 in the adjacent support assemblies 12 which supply atomizing air, cylinder and control air though the manifold 10, as best shown in FIG. 3. The support assemblies 12 in this case are blocks 51 within which the fluid conduits 50 are supported. The fluid conduits 50 each preferably extend outwardly a small distance beyond the respective ends of the blocks 51 for insertion into the passages of the spray gun manifold, with a threadless union therebetween (see. e.g., FIG. 3). Threaded retaining rods 52 in this instance extend through aligned holes 53 in the spray gun modules 11 and support assemblies 12 for retaining the modules and support assemblies in assembled relation to each other.

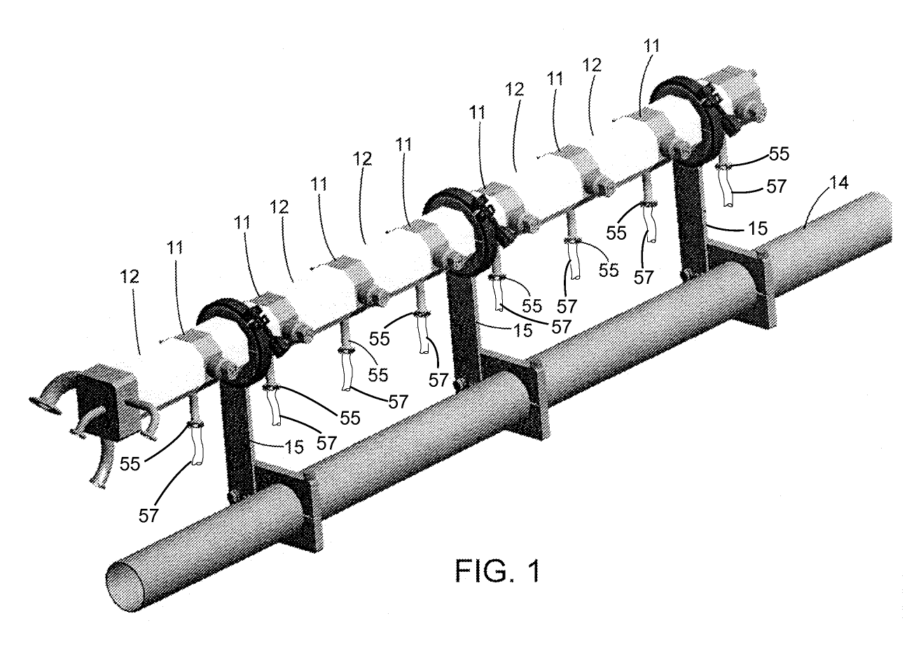

In accordance with one aspect of the invention, each spray gun module has a respective individual pressurized liquid feed or supply, which lends itself to reliable monitoring of the spray discharge while permitting circulation of the supply liquid through the manifold for return to the liquid supply. To this end, the liquid inlet 25 of each spray gun module housing block 15 is connected to a respective liquid supply 54. In the illustrated embodiment, each nozzle body 15 has a liquid inlet fitting 55 (FIG. 1) protruding outwardly of the spray gun module for easy connection to a supply line 57 coupled to the liquid supply. It will be understood by a person skilled in the art that the inlet fittings 55 and respective supply lines may be coupled to individual liquid supply pumps, or alternatively to a multiple feed pump operable for selectively directing pressurized liquid individually to the inlet fittings 55 and the respective spray gun modules 11.

In keeping with the illustrated embodiment, when the valve needle 35 is moved to the off or closed position, as depicted in FIG. 6, the liquid inlet 25 is enabled to communicate with a recirculation port 60 extending transversely to the block housing 15 of the spray gun modulell for permitting continued recirculation of the liquid through the manifold 10 via passages in the spray gun modules 11 and support assemblies 15. To this end, the valve needle 35 carries a plunger 62 intermediate its end which is movable within an enlarged passage section 6 upstream of the central fluid passageway 30 (FIG. 4A). The plunger 62 includes an outer annular seal 64 for sealing slide-able contact with the enlarged passageway section 6.

When the valve needle 35 is in the open position during spraying (FIG. 4A), the plunger 62 is disposed at a location between the liquid inlet 25 and the recirculation port 60 preventing the communication of liquid from the liquid inlet 25 to the recirculation port 60. As an incident to movement of the valve needle 35 to the shutoff position, as shown in FIG. 6A under the force of the spring 38 upon discontinuation of the actuating air, the plunger 62 is moved with the valve needle 35 to a position downstream of the liquid inlet 25 for permitting the continuous communication of liquid from the liquid inlet 25 to the recirculation port 60 for recirculation through the manifold 10. For this purpose, the recirculation port 60 extends transversely through the block housing 15 for communicating with recirculation tubes 64 in the adjacent support assemblies 12, which thereby enable the liquid to be recirculated through the manifold and return to the liquid supply regardless of whether the valve needles in the other spray gun modules 11 are in open or closed positions.

Hence, it can be seen that a spray gun manifold is provided in which the spray guns modules have individual liquid feeds or supplies that enables more reliable monitoring of interruptions or changes in liquid pressure and spray discharge. Yet, the spray gun modules enable automatic recirculation of the supply liquid through the manifold system when any of the valve needles of any of the spray gun modules are in their shutoff positions.

1. A modular spray gun manifold comprising:
a plurality of spray gun modules arranged in a lateral array with lateral sides of said spray gun modules being in spaced relation from each other along said array, a respective support assembly arranged between adjacent pair of spray gun modules for supporting the adjacent pair of spray gun modules in laterally spaced relation to each other;
said spray gun modules each including a nozzle body disposed between a respective pair of said support modules and a spray nozzle having a liquid discharge orifice;
said nozzle body defining a central liquid passageway communicating with said spray nozzle discharge orifice;
a valve needle disposed within said central liquid passageway for reciprocating movement between a valve closing position for preventing discharge of liquid from said spray nozzle discharge orifice and a valve open position for enabling liquid passage through said central passageway and spray tip discharge orifice, said support assemblies having fluid conduits for communicating pressurized air from a pressurized air source successively through said support assemblies and spray gun modules for atomizing, shaping, or controlling liquid discharge from the spray gun modules, said spray gun modules each having a respective liquid inlet communicating between a liquid supply and the central liquid passageway of the spray gun module, said liquid inlet of each spray gun module communicating through an outer side of the spray gun module at a location intermediate adjacent support assemblies, said support assemblies each having a liquid recirculation conduit for communicating liquid successively through said support assemblies and spray gun modules for return to a liquid supply source, said spray gun modules each having a recirculation port communicating between the central liquid passageway of the spray gun module and a recirculation conduit of an adjacent support assembly, said valve needle of each spray gun module being operable when in the open position for enabling communication of liquid from the respective inlet of the spray gun module through the central liquid passageway for discharge from the spray nozzle discharge orifice while blocking the communication of liquid from the central liquid passage to the recirculation port of the spray gun module, and said valve needle of each spray gun module being operable when in the valve closing position for blocking the flow of liquid from the central liquid passage of the spray gun module to the spray nozzle discharge orifice and redirecting liquid from the liquid inlet to the recirculation port of the spray gun module for communication to the recirculation conduit of an adjacent support assembly for recirculation to the liquid supply source.

2. The spray gun manifold of claim 1, in which each spray gun module has an independently controllable liquid supply.

3. The spray gun manifold of claim 1, in which the liquid inlet of each said spray gun module communicates with said central liquid passageway at a first location, said liquid recirculation port communicates with said central liquid passage at a second location spaced from the first location, said valve needle having a spool disposed at a location intermediate said liquid inlet port and liquid recirculation port when said valve needle is in said open position for enabling the flow of liquid through said central liquid passage and spray tip discharge orifice while blocking the flow of liquid from said liquid inlet to said recirculation port.

4. The spray gun manifold of claim 3, in which valve needles of said spray gun modules are independently controllable so that when the valve needle of one of said spray gun modules is said closing position liquid communicates from the liquid inlet of the spray gun module to the recirculation port of the spray gun module and the recirculation conduit of an adjacent support assembly regardless of whether the valve needles of other of the spray gun modules are in closed positions.

5. The spray gun manifold of claim 3, in which said spool of the valve needle of each spray gun module when the valve needle is in said closed position being disposed at a location for permitting communication of liquid from said liquid inlet port to central liquid passage and recirculation port to the recirculation conduit of the adjacent support assembly.

6. The spray gun manifold of claim 3, in which the liquid inlet of each spray gun module communicates with the central liquid passageway at a location along the central liquid passageway intermediate the spray nozzle discharge orifice and the recirculation port of the spray gun module.

7. The spray gun manifold of claim 1, in which each spray gun module has a respective liquid supply line externally of said spray gun module communicating between the liquid inlet module and liquid supply of the spray gun module.

8. The spray gun manifold of claim 7, in which the liquid inlet of each spray gun module extends transversely between the central longitudinal passageway and an outer side of the spray gun module.

9. The spray gun manifold of claim 1, including an actuator for selectively moving the valve need of each spray gun module between said open and closing positions.

10. The spray gun manifold of claim 1, in which the spray nozzle of each spray gun module includes an air cap and one of the fluid conduits in each of the support assemblies communicates pressurized air to the respective air caps of the spray gun modules.

11. A modular spray gun manifold comprising:
a plurality of spray gun modules arranged in a lateral array with lateral sides of said spray gun modules being in spaced relation from each other along said array, a respective support assembly arranged between adjacent pair of spray gun modules for supporting the adjacent pair of spray gun modules in laterally spaced relation to each other;
said spray gun modules each including a nozzle body disposed between a respective pair of said support modules and a spray nozzle having a liquid discharge orifice;
said nozzle body defining a central liquid passageway communicating with said spray nozzle discharge orifice;
a valve disposed within said central liquid passageway for reciprocating movement between a valve closing position for preventing discharge of liquid from said spray nozzle discharge orifice and a valve open position for enabling liquid passage through said central passageway and spray nozzle discharge orifice, said spray gun modules each having a respective liquid inlet communicating with the central liquid passageway of the spray gun module, said liquid inlet of each spray gun module communicating through an outer side of the spray gun module at a location intermediate adjacent support assemblies for connection to a liquid supply located externally of the spray gun module, said liquid supplies of said spray gun module being independently controllable, said support assemblies each having a liquid recirculation conduit for communicating liquid successively through said support assemblies and spray gun modules for return to a liquid supply source, said spray gun modules each having a recirculation port communicating between the central liquid passageway of the spray gun module and a recirculation conduit of an adjacent support assembly, said valve of each spray gun module being operable when in the open position for enabling communication of liquid from the respective inlet of the spray gun module through the central liquid passageway for discharge from the spray nozzle discharge orifice while blocking the communication of liquid from the central liquid passage to the recirculation port of the spray gun module, and said valve of each spray gun module being operable when in the valve closing position for blocking the flow of liquid from the central liquid passage of the spray gun module to the spray nozzle discharge orifice and redirecting liquid from the liquid inlet to the recirculation port of the spray gun module for communication to the recirculation conduit of an adjacent support assembly for recirculation to the liquid supply source.

12. The spray gun manifold of claim 11, in which the liquid inlet of each said spray gun module communicates with the central liquid passageway of the spray gun module at a first location, said liquid recirculation port of each spray gun module communicating with said central liquid passage at a second location spaced from the first location, said valve having a spool disposed at a location intermediate said liquid inlet port and liquid recirculation port when said valve is in said open position for enabling the flow of liquid through said central liquid passage and spray nozzle discharge orifice while blocking the flow of liquid from said liquid inlet to said recirculation port of the spray gun module.

13. The spray gun manifold of claim 12, in which said spool of the valve of each spray gun module when in said closed position being disposed at a location for permitting communication of liquid from said liquid inlet port and central liquid passageway to the recirculation port of the spray gun module and recirculation conduit of the adjacent support assembly.

14. The spray gun manifold of claim 13, in which the liquid inlet of each spray gun module communicates with the central liquid passageway at a location along the central liquid passageway intermediate the spray nozzle discharge orifice and the recirculation port of the spray gun module.

15. The spray gun manifold of claim 11, in which the liquid inlet of each spray gun module extends transversely between the central longitudinal passageway and an outer side of the spray gun module.
